(19) United States
(12) Patent Application Publication
(10) Pub. No.: US 2024/0196333 A1
(43) Pub. Date: Jun. 13, 2024

(54) METHOD FOR RELAXATION MEASUREMENT, TERMINAL AND STORAGE MEDIUM

(71) Applicant: BEIJING XIAOMI MOBILE SOFTWARE CO., LTD., Beijing (CN)

(72) Inventor: Ziquan HU, Beijing (CN)

(73) Assignee: BEIJING XIAOMI MOBILE SOFTWARE CO., LTD., Beijing (CN)

(21) Appl. No.: 18/285,232

(22) PCT Filed: Apr. 2, 2021
(86) PCT No.: PCT/CN2021/085165

§ 371 Date: Sep. 29, 2023

(51) Int. Cl. H04W 52/02; H04W 24/04

(52) U.S. Cl. CPC H04W 52/0238; H04W 24/04

(57) ABSTRACT

A method for relaxation measurement executed by a terminal includes: according to a determination result of whether predetermined conditions are met, determining an operation for triggering the relaxation measurement of beam failure detection (BFD), where the predetermined conditions at least indicate: radio link transmission quality for triggering relaxation measurement.

### CROSS REFERENCE

The present application is a national phase application of International Application No. PCT/CN2021/085165, filed on Apr. 2, 2021, and the entire contents thereof are incorporated herein by reference for all purposes.

### TECHNICAL FIELD

The present disclosure relates to the field of wireless communication technology but is not limited thereto, and in particular, to a relaxed measurement method, terminal, and storage medium.

### BACKGROUND

The fifth generation (5G, 5th Generation) mobile communication technology new radio (NR) system can support larger bandwidth and more diverse service types than the long-term evolution (LTE) system.

It should be noted that, information disclosed in the above background portion is provided only for better understanding of the background of the present disclosure, and thus it may contain information that does not form the prior art known by those ordinary skilled in the art.

### SUMMARY

The embodiments of the present disclosure disclose a method, terminal, and storage medium for relaxed measurement.

According to a first aspect of an embodiment of the present disclosure, a method for relaxed measurement is provided, where the method is executed by a terminal, and the method includes:
determining to trigger relaxed measurement of beam failure detection (BFD) according to a determination result of whether a predetermined condition is satisfied;
where the predetermined condition at least indicates: transmission quality of a wireless link that triggers relaxed measurement.

According to a second aspect of the embodiment of the present disclosure, a terminal includes a processor, where:
the processor is configured to:
determine to trigger relaxed measurement of BFD according to a determination result of whether a predetermined condition is satisfied;
where the predetermined condition at least indicates: transmission quality of a wireless link that triggers relaxed measurement.

According to a third aspect of the embodiment of the present disclosure, a terminal, where the terminal includes:
a processor; and
a memory for storing instructions executable by the processor;
where the processor is configured to: execute the executable instructions, to implement the method of any embodiment of the present disclosure.

According to a fourth aspect, a computer storage medium is provided, which stores computer-executable instructions, which when being executed by a processor, implement the method of any embodiment of the present disclosure.

It is to be understood that both the foregoing general description and the following detailed description are exemplary and explanatory only and are not restrictive of the disclosure, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is a schematic structural diagram of a wireless communication system according to an embodiment.

FIG. 2 is a schematic flowchart of a relaxed measurement method according to an embodiment.

FIG. 3 is a schematic flowchart of a relaxed measurement method according to an embodiment.

FIG. 4 is a schematic flowchart of a relaxed measurement method according to an embodiment.

FIG. 5 is a schematic flowchart of a relaxed measurement method according to an embodiment.

FIG. 6 is a schematic flowchart of a relaxed measurement method according to an embodiment.

FIG. 7 is a schematic flowchart of a relaxed measurement method according to an embodiment.

FIG. 8 is a schematic flowchart of a relaxed measurement method according to an embodiment.

FIG. 9 is a schematic flowchart of a relaxed measurement method according to an embodiment.

FIG. 10 is a schematic diagram of a terminal according to an embodiment.

FIG. 11 is a schematic structural diagram of a terminal according to an embodiment.

FIG. 12 is a block diagram of a base station according to an embodiment.

### DETAILED DESCRIPTION

Embodiments will be described in detail herein, examples of which are illustrated in the accompanying drawings. When the following description refers to the drawings, the same numbers in different drawings refer to the same or similar elements unless otherwise indicated. The implementations described in the following embodiments do not represent all implementations consistent with embodiments of the present disclosure. Rather, they are merely examples of apparatus and methods consistent with aspects of embodiments of the present disclosure as detailed in the appended claims.

The terminology used in the embodiments of the present disclosure is for the purpose of describing specific embodiments only and is not intended to limit the embodiments of the present disclosure. As used in the embodiments of the present disclosure and the appended claims, the singular forms “a”, “an” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “while . . . ” or “in response to determining”.

For the purpose of simplicity and ease of understanding, the present disclosure uses the terms “greater than” or “less than” when characterizing the size relationship. However, those skilled in the art can understand that the term “greater than” also encompasses the meaning of “greater than or equal to”, and “less than” also encompasses the meaning of “less than or equal to”.

Referring to FIG. 1, a schematic structural diagram of a wireless communication system provided by an embodiment of the present disclosure is shown. As shown in FIG. 1, the wireless communication system is a communication system based on mobile communication technology. The wireless communication system may include several user equipment 110 and several base stations 120.

In the embodiment, the user equipment 110 may be a device that provides voice and/or data connectivity to the user. The user equipment 110 can communicate with one or more core networks via a radio access network (RAN), and the user equipment 110 can be an IoT user equipment, such as a sensor device, a mobile phone, and a computer with an IoT user equipment, for example, may be a fixed, portable, pocket, hand-held, computer built-in, or vehicle-mounted device. For example, station (STA), subscriber unit, subscriber station, mobile station, mobile, remote station, access point, remote terminal, access terminal, user terminal, user agent, user device, or user equipment. Alternatively, the user equipment 110 may also be equipment of an unmanned aerial vehicle. Alternatively, the user equipment 110 may also be a vehicle-mounted device, for example, a trip computer with a wireless communication function, or a wireless user device connected externally to the trip computer. Alternatively, the user equipment 110 may also be a roadside device, for example, may be a street lamp, a signal lamp, or other roadside devices with a wireless communication function.

The base station 120 may be a network side device in a wireless communication system, where the wireless communication system may be a 4th generation mobile communication (4G) system, also known as a long term evolution (LTE) system; or, the wireless communication system may also be a 5G system, also known as new air interface system or 5G NR system. Alternatively, the wireless communication system may also be a next-generation system of the 5G system. In the embodiment, the access network in the 5G system can be referred to as a NG-RAN (New Generation-Radio Access Network).

In the embodiment, the base station 120 may be an evolved base station (eNB) adopted in a 4G system. Alternatively, the base station 120 may also be a base station (gNB) adopting a central and distributed architecture in the 5G system. When the base station 120 adopts a central distributed architecture, it generally includes a central unit (CU) and at least two distributed units (DU). The central unit is provided with a packet data convergence protocol (PDCP) layer, a radio link layer control (RLC) layer, and a media access control (MAC) layer protocol stack; and the distributed unit is provided with a physical (PHY) layer protocol stack, and the embodiment of the present disclosure does not limit the specific implementation manner of the base station 120.

A wireless connection may be established between the base station 120 and the user equipment 110 through a wireless air interface. In different embodiments, the wireless air interface is a wireless air interface based on the fourth-generation mobile communication network technology (4G) standard; or, the wireless air interface is a wireless air interface based on the fifth-generation mobile communication network technology (5G) standard. For example, the wireless air interface is a new air interface; alternatively, the wireless air interface may also be a wireless air interface based on a technical standard of a next-generation mobile communication network based on 5G.

In some embodiments, an E2E (end-to-end) connection may also be established between user equipment 110. For example, the scenario such as a V2V (vehicle to vehicle) communication, a V2I (vehicle to Infrastructure) communication and a V2P (vehicle to pedestrian) communication in the vehicle to everything (V2X) communication.

Here, the above user equipment may be regarded as the terminal device in the following embodiments.

In some embodiments, the foregoing wireless communication system may further include a network management device 130.

Several base stations 120 are connected to the network management device 130 respectively. Where, the network management device 130 may be a core network device in a wireless communication system, for example, the network management device 130 may be a mobility management entity (MME). Alternatively, the network management device may also be other core network devices, such as a serving gateway (SGW), a public data network gateway (PGW), a policy and charging rules functional (PCRF) or home subscriber server (HSS), etc. The implementation form of the network management device 130 is not limited in this embodiment of the present disclosure.

In order to facilitate the understanding of those skilled in the art, the embodiments of the present disclosure list a plurality of implementation manners to clearly illustrate the technical solutions of the embodiments of the present disclosure. Of course, those skilled in the art can understand that the multiple embodiments provided by the embodiments of the present disclosure can be executed independently, or combined with the methods of other embodiments in the embodiments of the present disclosure, and can also be executed together with some methods in other related technologies alone or after being combined; this is not limited in the embodiment of the present disclosure.

In order to better understand the technical solution described in any embodiment of the present disclosure, first, the relevant application scenarios of BFD are explained.

In one embodiment, a BFD mechanism is designed for the primary cell (Pcell), the primary secondary cell (PSCell) and the secondary cell (Scell). The terminal measures the Physical Downlink Control Channel (PDCCH) to determine the link quality corresponding to the downlink transmit beam; if the corresponding link quality is less than the quality threshold, it is considered that the downlink transmit beam has failed.

In one embodiment, the terminal periodically measures a periodic channel state information reference signal (CSI-RS) for beam failure detection. The measurement result is the signal to interference plus noise ratio (SINR) value of CSI-RS. The block error rate (BLER) value corresponding to the SINR is compared with the threshold Q_{out_LR} to determine the service beam quality. The physical layer reports the results to the media access control (MAC) layer.

In one embodiment, during the evaluation period T_{Evaluate_BFD}, it is evaluated whether the measurement results are lower than the threshold Q_{out_LR}. If all the measurement results are lower than the Q_{out_LR}, the physical layer is triggered to report the beam failure instance indication (BFI, Beam Failure Indication) to the MAC layer.

In one embodiment, an indication interval T_{indication-BFD} is defined, and the terminal triggers the physical layer to report the BFI to the MAC layer every T_{indication-BFD}.

In one embodiment, the MAC layer maintains related beam failure detection timer (BFD timer, beamFailureDetectionTimer) and beam failure counter BFI_counter. When the MAC layer receives a BFI, the BFD timer is started; and meanwhile, the BFI_counter counts by 1. If the BFD timer expires, the BFI_counter will be reset to 0. If the BFI_counter reaches the specified maximum value (beamFailureInstanceMaxCount) during the running duration of the BFD timer, the terminal determines that a beam failure has occurred.

Here, the above solution does not consider the power consumption of the terminal. When the terminal meets certain conditions, the terminal can relax the BFD measurement behavior, thereby saving the terminal power.

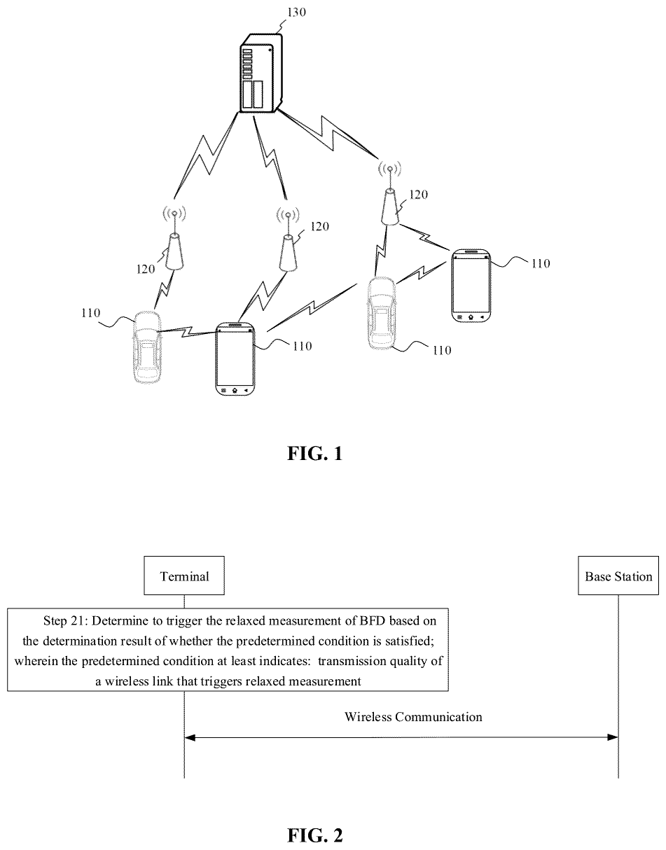

As shown in FIG. 2, this embodiment provides a method for relaxed measurement, where the method is executed by a terminal. The method includes the following.

Step 21: Determine to trigger the relaxed measurement of the beam failure detection BFD based on the determination result of whether the predetermined condition is satisfied.

In the embodiment, the predetermined condition at least indicates: transmission quality of a wireless link that triggers relaxed measurement.

Here, the terminal may be, but is not limited to, a mobile phone, a wearable device, a vehicle-mounted terminal, a roadside unit (RSU), a smart home terminal, an industrial sensing device and/or a medical device, etc.

In one embodiment, the wireless link may be a wireless link between the terminal and the base station. Here, the wireless link may be a PDCCH link.

Here, the base station may be an access device for terminals to access the network. Here, the base station may be various types of base stations, for example, a base station of a third generation mobile communication (3G) network, a base station of a fourth generation mobile communication (4G) network, a base station of a fifth generation mobile communication (5G) network, or other evolved base station.

In one embodiment, the base station can send reference signals such as CSI-RS to the terminal through a wireless link, and the terminal measures the reference signal in real time to determine the wireless link transmission quality. Here, the wireless link transmission quality can be indicated by different parameters. For example, this parameter can be the BLER and the like.

In one embodiment, in response to the determination result indicating that the predetermined condition is satisfied, it is determined to trigger the relaxed measurement of BFD; or in response to the determination result indicating that the predetermined condition is not satisfied, it is determined not to trigger the relaxed measurement of BFD.

In some embodiments, the predetermined conditions include one or more of the following:
1. The BLER is less than or equal to the BLER threshold;
2. The BFD timer is not started;
3. The count value of the counter of the MAC layer of the terminal is equal to the counting threshold, where the counter counts in response to the MAC layer receiving the power saving indication reported by the physical layer of the terminal when detecting that BLER is less than or equal to the BLER threshold; and in response to triggering the relaxed measurement of BFD, the counter is reset to the initial value;
4. The running duration of the preset timer of the physical layer is smaller than the timing period.

In one embodiment, in response to the BLER being less than or equal to the BLER threshold and the BFD timer not being started, it is determined to trigger the relaxed measurement of BFD. Here, in response to the MAC layer receiving the BFI sent by the physical layer, the BFD timer is started. Here, the BLER threshold is smaller than Q_{out_LR}, where Q_{out_LR} is the threshold that triggers the physical layer to report the BFI to the MAC layer once when BFD does not use relaxed measurement.

In one embodiment, in response to the BLER being less than or equal to the BLER threshold and the BFD timer is started, it is determined not to trigger the relaxed measurement of BFD.

In one embodiment, in response to the count value of the counter of the MAC layer of the terminal being equal to the counting threshold, it is determined that the relaxed measurement of BFD is triggered; or in response to the count value of the counter of the MAC layer of the terminal being less than the counting threshold, it is determined that the relax measurement of BFD is not triggered.

In one embodiment, in response to the block bit error rate BLER being less than or equal to the BLER threshold within the running duration of the preset timer of the physical layer of the terminal, it is determined to trigger the relaxed measurement of BFD; or, in response to the BLER being greater than the BLER threshold within the running duration of the preset timer of the physical layer of the terminal, it is determined that the relaxed measurement of BFD is not triggered.

In one embodiment, the terminal determines whether the predetermined condition is satisfied at the MAC layer of the terminal. For example, the terminal determines whether the BLER is less than or equal to the BLER threshold at the MAC layer. Here, in response to the physical layer of the terminal determining that the BLER is less than or equal to the BLER threshold, the physical layer reports a power saving indication to the MAC layer. The power saving indication is used to indicate that the BLER is less than or equal to the BLER threshold.

In one embodiment, after the terminal determines at the MAC layer that the predetermined condition is satisfied, the MAC layer will notify the physical layer to trigger relaxed measurement of the beam failure detection BFD.

In one embodiment, in response to the MAC layer of the terminal receiving a power saving indication from the physical layer, the block error rate BLER indicated by the power saving indication being less than or equal to the BLER threshold, and the BFD timer not being started, it is determined to trigger the physical layer to perform relaxed measurement of BFD. Here, the BLER is the BLER corresponding to the currently measured SINR.

In one embodiment, in response to the count value of the counter of the terminal's media access control MAC layer being equal to the counting threshold, it is determined to trigger the relaxed measurement of BFD at the physical layer, where the counter counts in response to the MAC layer receiving the power saving indication reported by the terminal's physical layer when detecting that the BLER is less than or equal to the BLER threshold; and the counter is reset to the initial value in response to triggering the relaxed measurement of BFD.

In one embodiment, the terminal determines whether the predetermined condition is satisfied at the physical layer of the terminal.

In one embodiment, the BLER threshold may be maintained through the physical layer, or the physical layer obtains the BLER threshold from the MAC layer through an inter-layer interface.

In one embodiment, the physical layer obtains the BFD timer information from the MAC layer through the inter-layer interface. Here, the BFD timer information may indicate whether the BFD timer is started.

In one embodiment, in response to the physical layer of the terminal receiving the BFD timer information of the MAC layer, the BFD timer information indicating that the BFD timer has not been started and the block error rate BLER being less than or equal to the BLER threshold, it is determined to trigger the physical layer to perform the relaxed measurement of BFD. Here, the BLER is the BLER corresponding to the currently measured SINR.

In one embodiment, in response to the block bit error rate BLER within the running duration of the preset timer of the physical layer of the terminal being less than or equal to the BLER threshold, it is determined to trigger the relaxed measurement of BFD at the physical layer. Here, the preset timer can be a newly introduced timer (T_{RLM_delta}), and the value range of the timing time T can be 0 to 1 second. For example, T can be 500 milliseconds and the like.

In one embodiment, the relaxed measurement of BFD may be a relaxed measurement of BFD using relaxation in the time domain.

In one embodiment, the relaxed measurement of BFD may be a relaxed measurement of BFD performed using an evaluation period expanded by an expansion coefficient. For example, the evaluation period before expansion is t1, and the evaluation period after expansion using the expansion coefficient is a times of t1, where a is a positive number greater than 1.

In one embodiment, the relaxed measurement of BFD may be a relaxed measurement of BFD performed using an indication interval expanded by an expansion coefficient. For example, the indication interval before expansion is t2, and the indication interval after expansion using the expansion coefficient is b times of t2, where b is a positive number greater than 1.

In one embodiment, the expansion factor of the expansion evaluation period and the indication interval may be the same.

In one embodiment, the relaxed measurement of BFD may be a relaxed measurement of BFD employing a reduced number of measured reference signals.

For example, the number of reference signals for BFD measurement is reduced from a to b.

In one embodiment, the relaxed measurement of BFD may be to reduce the BFD measurement frequency domain range in the frequency domain.

For example, the measurement part bandwidth BWP1 of the BFD is reduced to the bandwidth BWP2.

In one embodiment, relaxed measurement methods of different relaxation levels may be used for relaxed measurement.

In one embodiment, the relaxed measurement is in the relaxed measurement of BFD with an extended evaluation period. The first mode is: if BLER_{curren}≤Qp1, the physical layer reports the power saving indication 1 to the MAC and the MAC determines that the current BFD timer is not started, triggering the BFD to relax the evaluation cycle by the expansion factor a and perform relaxed measurement; the second mode is: if BLER_{current}≤Qp2 (Qp1<Qp2<Q_{out_LR}), the physical layer reports the power saving indication 2 to the MAC and the MAC determines that the current BFD timer is not started, triggering the BFD to relax the evaluation cycle by expansion factor b and perform relaxed measurement, where a>b; here, the relaxation level of the first mode is higher than the relaxation level of the second mode.

In one embodiment, in the relaxed measurement method of BFD that reduces the number of measured reference signals, the first mode is: reducing the number of reference signals to c; the second mode is: reducing the number of reference signals to d. Here, if c>d, the relaxation level of the first mode is lower than the relaxation level of the second mode.

In one embodiment, in the relaxed measurement method of BFD that reduces the BFD measurement frequency domain range in the frequency domain, the first mode is: reducing the BWP measured by BFD to BWP1; the second mode is: reducing the BWP measured by BFD to BWP2. Here, if BWP1 is smaller than BWP2, the relaxation level of the first mode is higher than the relaxation level of the second mode.

In one embodiment, after the relaxed measurement of BFD is triggered, in response to the BLER being greater than the BLER threshold, the relaxed measurement of BFD is stopped.

In one embodiment, in response to the terminal reporting the beam failure instance indication BFI, BFD relaxed measurement is stopped.

In one embodiment, relaxed measurements of the BFD are stopped in response to the BFD timer running.

In the embodiment of the present disclosure, the operation of triggering the relaxed measurement of the beam failure detection BFD is determined based on the determination result of whether the predetermined condition is satisfied; where the predetermined condition at least indicates: the wireless link transmission quality that triggers the relaxed measurement. Here, the terminal can determine whether to trigger relaxed measurement of BFD or not to trigger relaxed measurement of BFD based on the determination result of whether the predetermined condition is satisfied. Compared with the mode in which relaxed measurement of BFD is always not used, it can adapt to the wireless link transmission quality, and trigger the relaxed measurement of BFD, thereby adjusting the power consumption of BFD, saving power, and improving the battery life of the terminal.

It should be noted that those skilled in the art can understand that the methods provided in the embodiments of the present disclosure can be executed alone or together with some methods in the embodiments of the present disclosure or some methods in related technologies.

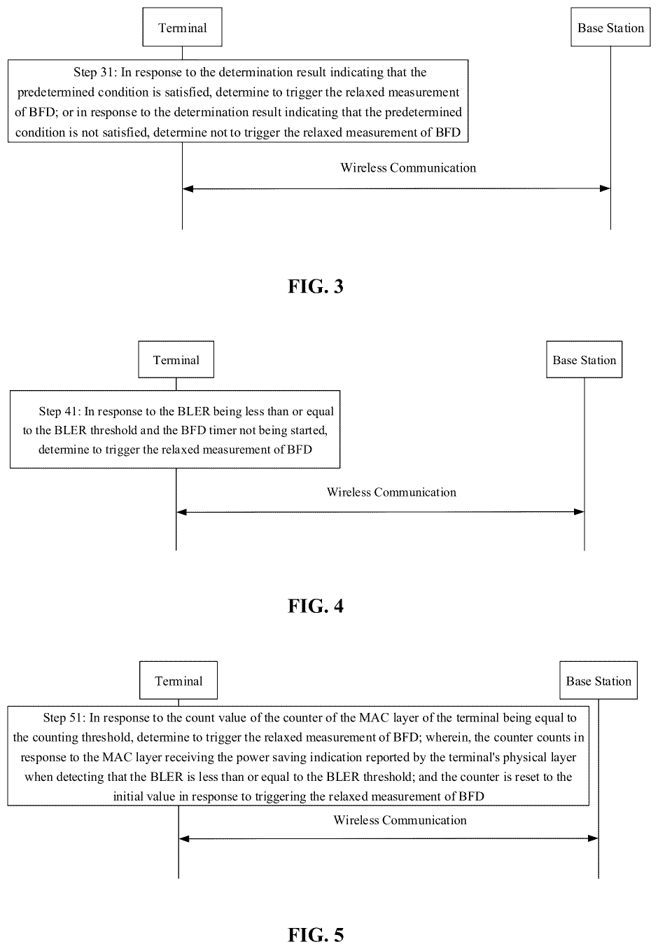

As shown in FIG. 3, this embodiment provides a method for relaxing measurement, where the method is executed by a terminal. The method includes the following.

Step 31: In response to the determination result indicating that the predetermined condition is satisfied, determine to trigger the relaxed measurement of BFD; or in response to the determination result indicating that the predetermined condition is not satisfied, determine not to trigger the relaxed measurement of BFD.

In one embodiment, in response to the BLER being less than or equal to the BLER threshold and the BFD timer not being started, it is determined to trigger the relaxed measurement of BFD. Here, in response to the MAC layer receiving the BFI sent by the physical layer, the BFD timer is started. Here, the BLER threshold is smaller than Q_{out_LR}, where Q_{out_LR} is the threshold that triggers one report of BFI from the physical layer to the MAC layer in the case that the BFD does not use relaxed measurement.

In one embodiment, in response to the BLER being less than or equal to the BLER threshold and the BFD timer being started, it is determined not to trigger the relaxed measurement of BFD.

In one embodiment, in response to the count value of the counter of the MAC layer of the terminal being equal to the counting threshold, it is determined that the relaxed measurement of BFD is triggered; or in response to the count value of the counter of the MAC layer of the terminal being less than the counting threshold, it is determined that relaxed measurement of BFD is not triggered.

In one embodiment, in response to the BLER within the running duration of the preset timer of the terminal's physical layer being smaller than the BLER threshold, it is determined to trigger the relaxed measurement of BFD; or, in response to the BLER within the running duration of the preset timer of the terminal's physical layer being greater than the BLER threshold, it is determined not to trigger the relaxed measurement of BFD.

In one embodiment, the terminal determines whether the predetermined condition is met at the MAC layer of the terminal. For example, the terminal determines whether the BLER is less than or equal to the BLER threshold at the MAC layer. Here, in response to the terminal's physical layer determining that the BLER is less than or equal to the BLER threshold, the physical layer reports a power saving indication to the MAC layer. The power saving indication is used to indicate that the BLER is less than or equal to the BLER threshold.

In one embodiment, after the terminal determines at the MAC layer that the predetermined condition is satisfied, the MAC layer will notify the physical layer to trigger relaxed measurement of the beam failure detection BFD.

In one embodiment, in response to the terminal's MAC layer receiving a power saving indication from the physical layer, the block error rate BLER indicated by the power saving indication being less than or equal to the BLER threshold, and the BFD timer not being started, it is determined to trigger the physical layer to perform relax measurement of BFD. Here, the BLER is the BLER corresponding to the currently measured SINR.

In one embodiment, in response to the count value of the counter of the terminal's media access control MAC layer being equal to the counting threshold, it is determined to trigger the relaxed measurement of BFD at the physical layer; where, in response to the MAC layer receiving the power saving indication reported by the terminal's physical layer when detecting that the BLER is smaller than or equal to the BLER threshold, the counter counts; and in response to triggering the relaxed measurement of BFD, the counter is reset to the initial value.

It should be noted that those skilled in the art can understand that the methods provided in the embodiments of the present disclosure can be executed alone or together with some methods in the embodiments of the present disclosure or some methods in related technologies.

As shown in FIG. 4, this embodiment provides a method for relaxing measurement, where the method is executed by a terminal. The method includes the followings.

Step 41: In response to the block bit error rate BLER being less than or equal to the BLER threshold and the BFD timer not being started, determine to trigger the relaxed measurement of BFD.

In one embodiment, the terminal determines whether the predetermined condition is met at the MAC layer of the terminal. For example, the terminal determines whether the BLER is less than or equal to the BLER threshold at the MAC layer. Here, in response to the terminal's physical layer determining that the BLER is less than or equal to the BLER threshold, the physical layer reports a power saving indication to the MAC layer. The power saving indication is used to indicate that the BLER is less than or equal to the BLER threshold.

In one embodiment, after the terminal determines at the MAC layer that the predetermined condition is satisfied, the MAC layer will notify the physical layer to trigger relaxed measurement of the beam failure detection BFD.

In one embodiment, in response to the terminal's MAC layer receiving a power saving indication from the physical layer, the block error rate BLER indicated by the power saving indication being less than or equal to the BLER threshold, and the BFD timer not being started, it is determined to trigger the physical layer to perform relax measurement of BFD. Here, the BLER is the BLER corresponding to the currently measured SINR.

In one embodiment, the terminal determines whether the predetermined condition is satisfied at the physical layer of the terminal.

In one embodiment, the BLER threshold may be maintained through the physical layer, or the physical layer obtains the BLER threshold from the MAC layer through an inter-layer interface.

In one embodiment, the physical layer obtains the BFD timer information from the MAC layer through the inter-layer interface. Here, the BFD timer information may indicate whether the BFD timer is started.

In one embodiment, in response to the physical layer of the terminal receiving the BFD timer information of the MAC layer, the BFD timer information indicating that the BFD timer has not been started and the block error rate BLER being less than or equal to the BLER threshold, it is determined to trigger the physical layer to perform the relaxed measurement of BFD. Here, the BLER is the BLER corresponding to the currently measured SINR.

It should be noted that those skilled in the art can understand that the methods provided in the embodiments of the present disclosure can be executed alone or together with some methods in the embodiments of the present disclosure or some methods in related technologies.

As shown in FIG. 5, this embodiment provides a method for relaxing measurement, where the method is executed by a terminal. The method includes the followings. Step 51: In response to the count value of the counter of the media access control MAC layer of the terminal being equal to the counting threshold, it is determined to trigger the relaxed measurement of BFD; where, the counter counts in response to the MAC layer receiving the power saving indication reported by the terminal's physical layer when detecting that the BLER is less than or equal to the BLER threshold; and the counter is reset to the initial value in response to triggering the relaxed measurement of BFD.

In one embodiment, the terminal determines whether the predetermined condition is satisfied at the MAC layer of the terminal. For example, the terminal determines whether the BLER is less than or equal to the BLER threshold at the MAC layer. Here, in response to the terminal's physical layer determining that the BLER is less than or equal to the BLER threshold, the physical layer reports a power saving indication to the MAC layer. The power saving indication is used to indicate that the BLER is less than or equal to the BLER threshold.

In one embodiment, in response to the count value of the counter of the media access control MAC layer of the terminal being equal to the counting threshold, it is determined to trigger the relaxed measurement of BFD at the physical layer; where, the counter counts in response to the MAC layer receiving the power saving indication reported by the terminal's physical layer when detecting that the BLER is less than or equal to the BLER threshold; and the counter is reset to the initial value in response to triggering the relaxed measurement of BFD.

It should be noted that those skilled in the art can understand that the methods provided in the embodiments of the present disclosure can be executed alone or together with some methods in the embodiments of the present disclosure or some methods in related technologies.

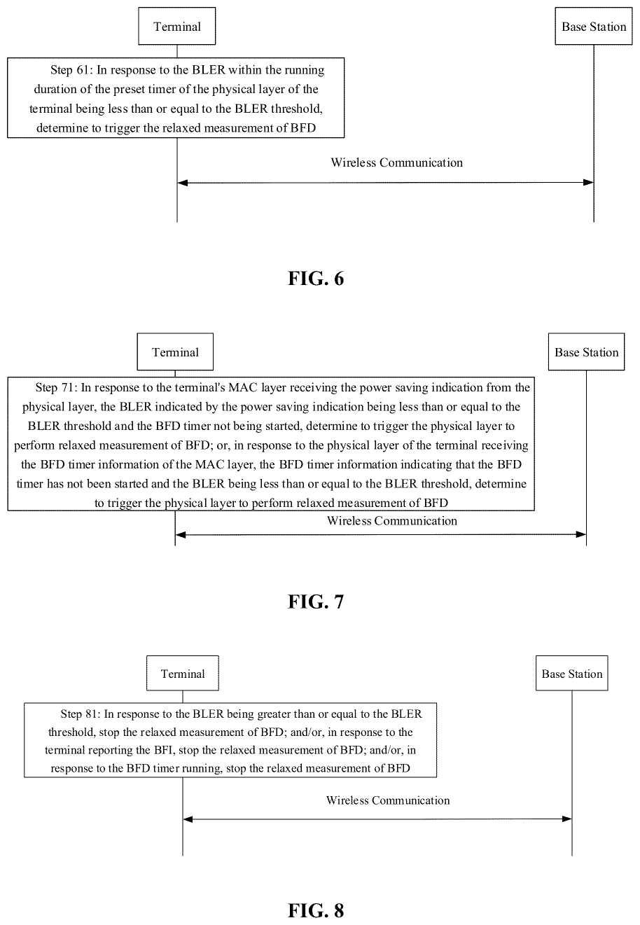

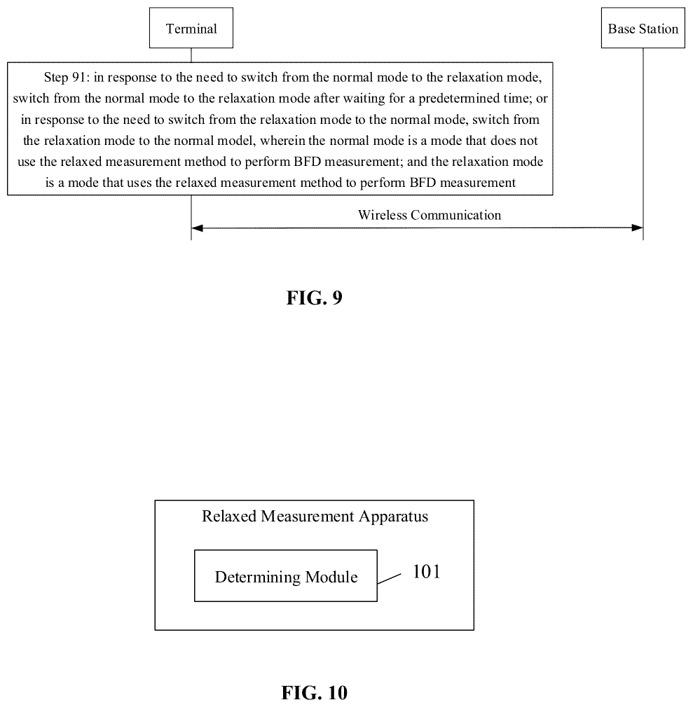

As shown in FIG. 6, this embodiment provides a method for relaxed measurement, where the method is executed by a terminal. The method includes the followings.

Step 61: In response to the block bit error rate BLER within the running duration of the preset timer of the physical layer of the terminal being less than or equal to the BLER threshold, determine to trigger the relaxed measurement of BFD.

In one embodiment, the terminal determines whether the predetermined condition is satisfied at the physical layer of the terminal.

In one embodiment, the BLER threshold may be maintained through the physical layer, or the physical layer obtains the BLER threshold from the MAC layer through an inter-layer interface.

In one embodiment, in response to the block bit error rate BLER within the running duration of the preset timer of the physical layer of the terminal being less than or equal to the BLER threshold, it is determined to trigger the relaxed measurement of BFD at the physical layer. Here, the preset timer can be a newly introduced timer (T_{RLM_delta}), and the value range of the timing time T can be 0 to 1 second. For example, T can be 500 milliseconds and the like.

It should be noted that those skilled in the art can understand that the methods provided in the embodiments of the present disclosure can be executed alone or together with some methods in the embodiments of the present disclosure or some methods in related technologies.

As shown in FIG. 7, this embodiment provides a method for relaxing measurement, where the method is executed by a terminal. The method includes the following.

Step 71: In response to the terminal's MAC layer receiving the power saving indication from the physical layer, the block error rate BLER indicated by the power saving indication being less than or equal to the BLER threshold and the BFD timer not being started, determine to trigger the physical layer to perform BFD relaxed measurement;
or,
in response to the physical layer of the terminal receiving the BFD timer information of the MAC layer, the BFD timer information indicating that the BFD timer has not been started and the block error rate BLER being less than or equal to the BLER threshold, it is determined to trigger the physical layer to perform relaxed measurement of BFD.

In one embodiment, the terminal determines whether the predetermined condition is met at the MAC layer of the terminal. For example, the terminal determines whether the BLER is less than or equal to the BLER threshold at the MAC layer. Here, in response to the terminal's physical layer determining that the BLER is less than or equal to the BLER threshold, the physical layer reports a power saving indication to the MAC layer. The power saving indication is used to indicate that the BLER is less than or equal to the BLER threshold.

In one embodiment, after the terminal determines at the MAC layer that the predetermined condition is satisfied, the MAC layer will notify the physical layer to trigger relaxed measurement of the beam failure detection BFD.

In one embodiment, in response to the terminal's MAC layer receiving a power saving indication from the physical layer, the block error rate BLER indicated by the power saving indication being less than or equal to the BLER threshold, and the BFD timer not being started, it is determined to trigger the physical layer to perform relax measurement of BFD. Here, the BLER is the BLER corresponding to the currently measured SINR.

In one embodiment, the terminal determines whether the predetermined condition is satisfied at the physical layer of the terminal.

In one embodiment, the BLER threshold may be maintained through the physical layer, or the physical layer obtains the BLER threshold from the MAC layer through an inter-layer interface.

In one embodiment, the physical layer obtains the BFD timer information from the MAC layer through the inter-layer interface. Here, the BFD timer information may indicate whether the BFD timer is started.

In one embodiment, in response to the physical layer of the terminal receiving the BFD timer information of the MAC layer, the BFD timer information indicating that the BFD timer has not been started and the block error rate BLER being less than or equal to the BLER threshold, it is determined to trigger the physical layer to perform the relaxed measurement of BFD. Here, the BLER is the BLER corresponding to the currently measured SINR.

It should be noted that those skilled in the art can understand that the methods provided in the embodiments of the present disclosure can be executed alone or together with some methods in the embodiments of the present disclosure or some methods in related technologies.

In one embodiment, the relaxed measurement parameters of relaxed measurement include one or more of:
a first relaxed measurement parameter indicating the evaluation period; where the evaluation period is N1 times of the reference evaluation period; where N1 is a positive number greater than 1;
a second relaxed measurement parameter indicating the indication interval; where the indication interval is N2 times of the reference indication interval; where the N2 bit is a positive number greater than 1;
a third relaxed measurement parameter indicating the number of reference signals RS; where the number of reference signals is less than the reference number threshold; and
a fourth relaxed measurement parameter indicating the frequency domain range of BFD measurement; where the frequency domain range is smaller than the reference frequency domain range.

Here, the reference evaluation period, the reference indication interval, the reference number threshold and/or the reference frequency domain range may be specified by the standard.

In one embodiment, the relaxed measurement of BFD may be a relaxed measurement of BFD performed using an evaluation period expanded by an expansion coefficient. For example, the evaluation period before expansion is t1, and the evaluation period after expansion using the expansion coefficient is N1 times of t1, where N1 is a positive number greater than 1.

In one embodiment, the relaxed measurement of BFD may be a relaxed measurement of BFD performed using an indication interval expanded by an expansion coefficient. For example, the indication interval before expansion is t2, and the indication interval after expansion using the expansion coefficient is N2 times of t2, where N2 is a positive number greater than 1.

In one embodiment, in one embodiment, the relaxed measurement of BFD may be a relaxed measurement of BFD employing a reduced number of measured reference signals. For example, the number of reference signals for BFD measurement is reduced from a to b. Here, b is smaller than the reference number threshold.

In one embodiment, the relaxed measurement of BFD may be to reduce the BFD measurement frequency domain range in the frequency domain. For example, the measurement part bandwidth BWP1 of the BFD is reduced to the bandwidth BWP2. Here, BWP2 is smaller than the reference threshold range.

It should be noted that those skilled in the art can understand that the methods provided in the embodiments of the present disclosure can be executed alone or together with some methods in the embodiments of the present disclosure or some methods in related technologies.

In one embodiment, in response to the evaluation period indicated by the first relaxed measurement parameter being greater than the evaluation period threshold, the relaxation degree of the relaxed measurement using the first relaxed measurement parameter is greater than the relaxation degree threshold;
or,
in response to the indication interval indicated by the second relaxed measurement parameter being greater than the indication interval threshold, the relaxation degree of the relaxed measurement using the second relaxed measurement parameter is greater than the relaxation degree threshold;
or,
in response to the number of reference signals indicated by the third relaxed measurement parameter being less than the reference number threshold, the relaxation degree of the relaxed measurement using the third relaxed measurement parameter is greater than the relaxation degree threshold;
or,
in response to the frequency domain range of the BFD measurement indicated by the fourth relaxed measurement parameter being smaller than the reference frequency domain range, the relaxation degree of the relaxed measurement using the fourth relaxed measurement parameter is greater than the relaxation degree threshold.

Here, the evaluation period threshold, the indication interval threshold, the reference number threshold and/or the reference frequency domain range may be specified by the standard.

In one embodiment, the relaxation degree may be used to characterize the degree of relaxation of time in the time domain. For example, the value of the relaxed measurement parameter corresponding to the first relaxation mode is 1 hour, which is used to instruct the terminal to stop measurement for 1 hour; the value of the relaxed measurement parameter corresponding to the second relaxation mode is 2 hours, and is used to instruct the terminal to stop measurement for 2 hours. Then the relaxation degree of the relaxed measurement based on the second relaxation mode is twice the relaxation degree of the relaxed measurement based on the first relaxation mode. For another example, the measurement relaxation parameter corresponding to the first relaxation mode is the indication interval, and the value of the indication interval is 10 ms; the measurement relaxation parameter corresponding to the second relaxation mode is the indication interval, and the value of the indication interval is 20 ms. Then the relaxation degree of the relaxed measurement based on the second relaxation mode is twice the relaxation degree of the relaxed measurement based on the first relaxation mode. That is, when performing the relaxed measurement, the second relaxation mode is a more relaxing method than the first relaxation mode. Therefore, the greater the degree of relaxation is, the more relaxing the corresponding relaxation mode is.

In one embodiment, the relaxation degree may be used to characterize the degree of relaxation in the number of the reference signal. For example, the number of measured reference signals corresponding to the first relaxation mode is 10; the number of measured reference signals corresponding to the second relaxation mode is 20, then the relaxation degree of the relaxed measurement based on the second relaxation mode is ½ times of the relaxation degree of the relaxed measurement based on the first relaxation mode.

In one embodiment, the relaxation degree may be a degree of relaxation used to characterize the frequency domain range. For example, the frequency domain range corresponding to the first relaxation mode is BWP1; the frequency domain range corresponding to the second relaxation mode is BWP2, and BWP1 is ½ of BWP2. Then the relaxation degree of the reflexed measurement based on the second relaxation mode is ½ times of the relaxation degree of the reflexed measurement based on the first relaxation mode.

It should be noted that those skilled in the art can understand that the methods provided in the embodiments of the present disclosure can be executed alone or together with some methods in the embodiments of the present disclosure or some methods in related technologies.

As shown in FIG. 8, this embodiment provides a method for relaxing measurement, where the method is executed by a terminal. The method includes the followings.

Step 81: In response to the BLER being greater than or equal to the BLER threshold, stop the relaxed measurement of BFD;
and/or,
in response to the terminal reporting the beam failure instance indication BFI, stop the relaxed measurement of BFD;
and/or,
in response to the BFD timer running, stop the relaxed measurement of BFD.

In one embodiment, in response to being triggered to perform the relaxed measurement of BFD and the BLER is greater than or equal to the BLER threshold, stop the relaxed measurement of BFD.

In one embodiment, in response to being triggered to perform the relaxed measurement of BFD and the terminal reporting the beam failure instance indication BFI, stop the relaxed measurement of BFD.

In one embodiment, in response to being triggered to perform the relaxed measurement of BFD and the BFD timer running, stop the relaxed measurement of BFD.

It should be noted that those skilled in the art can understand that the methods provided in the embodiments of the present disclosure can be executed alone or together with some methods in the embodiments of the present disclosure or some methods in related technologies.

As shown in FIG. 9, this embodiment provides a method for relaxed measurement, where the method is executed by a terminal. The method includes the followings.

Step 91: in response to the need to switch from the normal mode to the relaxation mode, switch from the normal mode to the relaxation mode after waiting for a predetermined time; or in response to the need to switch from the relaxation mode to the normal mode, switch from the relaxation mode to the normal model.

In the embodiment, the normal mode is a mode that does not use the relaxed measurement method to perform BFD measurement; and the relaxation mode is a mode that uses the relaxed measurement method to perform BFD measurement.

It should be noted that those skilled in the art can understand that the methods provided in the embodiments of the present disclosure can be executed alone or together with some methods in the embodiments of the present disclosure or some methods in related technologies.

As shown in 10, an embodiment of the present disclosure provides a terminal. The terminal includes a processor.
the processor 101 is configured to:
determine to trigger relaxed measurement of beam failure detection BFD according to a determination result of whether a predetermined condition is satisfied;
where the predetermined condition at least indicates: transmission quality of a wireless link that triggers relaxed measurement.

In one embodiment, the processor 101 is further configured to:
determine to trigger the relaxed measurement of BFD in response to the determination result indicating that the predetermined condition is satisfied;
or,
determine not to trigger the relaxed measurement of BFD in response to the determination result indicating that the predetermined condition is not satisfied.

In one embodiment, the processor 101 is further configured to:
determine to trigger the relaxed measurement of BFD in response to a block bit error rate BLER being less than or equal to a BLER threshold and a BFD timer not being started;
or,
determine to trigger the relaxed measurement of BFD in response to a count value of a counter of a media access control MAC layer of the terminal being equal to a counting threshold, where the counter counts in response to the MAC layer receiving a power saving indication reported by a physical layer of the terminal upon detection of the BLER being less than or equal to the BLER threshold, and the counter is reset to an initial value in response to triggering the relaxed measurement of BFD;
or,
determine to trigger the relaxed measurement of BFD in response to the BLER within a running duration of a preset timer of the physical layer of the terminal being smaller less than or equal to the BLER threshold

In one embodiment, the processor 101 is further configured to:
determine to trigger the relaxed measurement of BFD in response to the MAC layer of the terminal receiving the power saving indication of the physical layer, the BLER indicated by the power saving indication being than or equal to the BLER threshold and the BFD timer not being started;
or,
determine to trigger the relaxed measurement of BFD in response to the physical layer of the terminal receiving BFD timer information of the MAC layer, the BFD timer information indicating that the BFD timer is not started and the BLER being smaller than the BLER threshold.

It should be noted that those skilled in the art can understand that the methods provided in the embodiments of the present disclosure can be executed alone or together with some methods in the embodiments of the present disclosure or some methods in related technologies.

An embodiment of the present disclosure provides a terminal. The terminal includes:
a processor; and
a memory used to store instructions executable by the processor;
where the processor is configured to: when executing the executable instructions, implement the method applied to any embodiment of the present disclosure.

In the embodiment, the processor may include various types of storage media, which are non-transitory computer storage media that can continue to memorize information stored on the terminal after the terminal is powered off.

The processor can be connected to the memory through a bus and the like, which is used to read the executable program stored in the memory.

An embodiment of the present disclosure also provides a computer storage medium, where the computer storage medium stores a computer executable program, and when the executable program is executed by a processor, the method of any embodiment of the present disclosure is implemented.

Regarding the devices in the above embodiments, the specific manner in which each component performs operations has been described in detail in the embodiments related to the method, and will not be described in detail here.

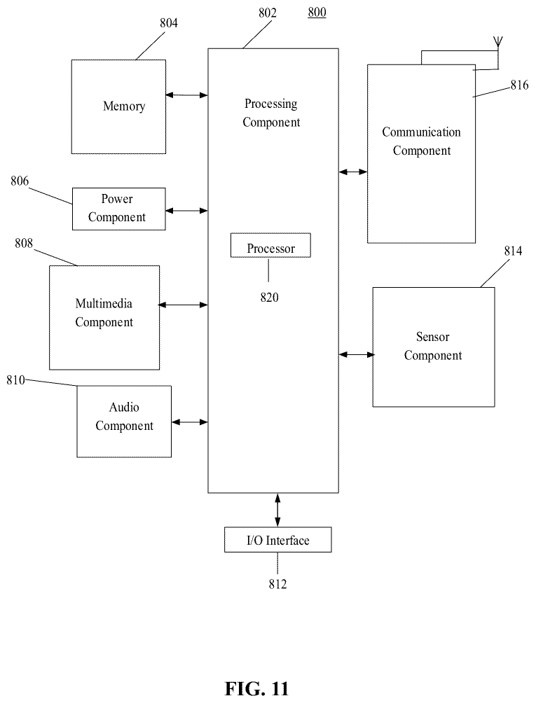

As shown in FIG. 11, one embodiment of the present disclosure provides a structure of a terminal.

Referring to FIG. 11, the terminal 800 is shown. The embodiment provides a terminal 800, which specifically can be a mobile phone, a computer, a digital broadcast terminal, a messaging device, a game console, a tablet device, a medical device, a fitness device, a personal digital assistant, and the like.

Referring to FIG. 11, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the terminal 800, such as operations associated with display, telephone calls, data communications, camera operations, and recording operations. The processing component 802 may include one or more processors 820 to execute instructions to complete all or part of the steps of the above method. Additionally, processing component 802 may include one or more subcomponents that facilitate interaction between processing component 802 and other components. For example, processing component 802 may include a multimedia processor to facilitate interaction between multimedia component 808 and processing component 802.

The memory 804 is configured to store various types of data to support operations at the device 800. Examples of such data include instructions for any application or method operating on the terminal 800, contact data, phonebook data, messages, pictures, videos, etc. The memory 804 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 806 provides power to various components of the terminal 800. The power component 806 may include a power management system, one or more power supplies, and other components associated with generating, managing, and distributing power for terminal 800.

The multimedia component 808 includes a screen providing an output interface between the terminal 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 808 includes a front camera and/or a rear camera. When the device 800 is in an operation mode, such as a photographing mode or a video mode, the front camera and/or the rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the terminal 800 is in an operation mode, such as a call mode, a recording mode and a voice recognition mode. Received audio signals may be further stored in memory 804 or sent via communication component 816. In some embodiments, the audio component 810 also includes a speaker for outputting audio signals.

The I/O interface 812 provides an interface between the processing component 802 and a peripheral interface equipment, which may be a keyboard, a click wheel, a button, and the like. These buttons may include, but are not limited to: a home button, volume buttons, start button, and lock button.

The sensor component 814 includes one or more sensors for providing terminal 800 with various aspects of status assessment. For example, the sensor component 814 can detect the open/closed state of the device 800, the relative positioning of components, such as the display and the keypad of the terminal 800, the sensor component 814 can also detect the terminal 800 or a change in the position of a component of the terminal 800, the presence or absence of user's contact with the terminal 800, the change of orientation or acceleration/deceleration of the terminal 800 and the temperature change of the terminal 800. The sensor component 814 may include a proximity sensor configured to detect the presence of nearby objects in the absence of any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the terminal 800 and other devices. The terminal 800 can access a wireless network based on communication standards, such as Wi-Fi, 2G or 3G, or a combination thereof. In an embodiment, the communication component 816 receives broadcast signals or broadcast related information from an external broadcast management system via a broadcast channel. In an embodiment, the communication component 816 also includes a near field communication (NFC) transmitter to facilitate short-range communication. For example, the NFC transmitter can be implemented based on radio frequency identification (RFID) technology, infrared data association (IrDA) technology, ultra wideband (UWB) technology, bluetooth (BT) technology and other technologies.

In an embodiment, terminal 800 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an embodiment, there is also provided a non-transitory computer-readable storage medium including instructions, such as the memory 804 including instructions, which can be executed by the processor 820 of the terminal 800 to implement the above method. For example, the non-transitory computer readable storage medium may be ROM, random access memory (RAM), CD-ROM, magnetic tape, floppy disk, and optical data storage device, and the like.

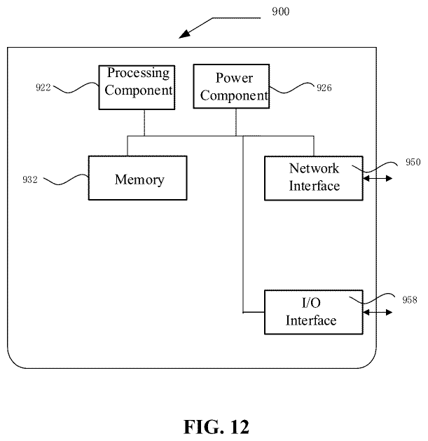

As shown in FIG. 12, an embodiment of the present disclosure shows a structure of a base station. For example, the base station 900 may be provided as a network side device. Referring to FIG. 12, the base station 900 includes a processing component 922, which further includes one or more processors, and a memory resource represented by a memory 932 for storing instructions executable by the processing component 922, such as application programs. The application program stored in memory 932 may include one or more components each corresponding to a set of instructions. In addition, the processing component 922 is configured to execute instructions, so as to perform any of the aforementioned methods applied to the base station.

Base station 900 may also include a power component 926 configured to perform power management of base station 900, a wired or wireless network interface 950 configured to connect base station 900 to a network, and an input-output (I/O) interface 958. The base station 900 can operate based on an operating system stored in the memory 932, such as Windows Server™, Mac OS X™, Unix™, Linux™, FreeBSD™ or the like.

According to a first aspect of an embodiment of the present disclosure, a method for relaxed measurement is provided, where the method is executed by a terminal, and the method includes:
determining to trigger relaxed measurement of beam failure detection BFD according to a determination result of whether a predetermined condition is satisfied;
where the predetermined condition at least indicates: transmission quality of a wireless link that triggers relaxed measurement.

In one embodiment, the determining to trigger the relaxed measurement of beam failure detection BFD according to the determination result of whether the predetermined condition is satisfied, includes:
determining to trigger the relaxed measurement of BFD in response to the determination result indicating that the predetermined condition is satisfied;
or,
determining not to trigger the relaxed measurement of BFD in response to the determination result indicating that the predetermined condition is not satisfied.

In one embodiment, the determining to trigger the relaxed measurement of BFD in response to the determination result indicating that the predetermined condition is satisfied, includes:
determining to trigger the relaxed measurement of BFD in response to a block bit error rate BLER being less than or equal to a BLER threshold and a BFD timer not being started;
or,
determining to trigger the relaxed measurement of BFD in response to a count value of a counter of a media access control MAC layer of the terminal being equal to a counting threshold, where the counter counts in response to the MAC layer receiving a power saving indication reported by a physical layer of the terminal upon detection of the BLER being less than or equal to the BLER threshold, and the counter is reset to an initial value in response to triggering the relaxed measurement of BFD;
or,
determining to trigger the relaxed measurement of BFD in response to the BLER within a running duration of a preset timer of the physical layer of the terminal being less than or equal to the BLER threshold.

In one embodiment, the determining to trigger the relaxed measurement of BFD in response to the block bit error rate BLER being less than or equal to the BLER threshold and the BFD timer not being started, includes:
determining to trigger the relaxed measurement of BFD in response to the MAC layer of the terminal receiving the power saving indication of the physical layer, the BLER indicated by the power saving indication being than or equal to the BLER threshold and the BFD timer not being started;
or,
determining to trigger the relaxed measurement of BFD in response to the physical layer of the terminal receiving BFD timer information of the MAC layer, the BFD timer information indicating that the BFD timer is not started and the BLER being smaller than the BLER threshold.

In one embodiment, the method further includes:
obtaining, by the physical layer, the BLER threshold from the MAC layer through an inter-layer interface.

In one embodiment, a relaxed measurement parameter of the relaxed measurement includes one or more of:
a first relaxed measurement parameter indicating an evaluation period; where the evaluation period is N1 times of a reference evaluation period; and where N1 is a positive number greater than 1;
a second relaxed measurement parameter indicating an indication interval; where the indication interval is N2 times of a reference indication interval; and where N2 is a positive number greater than 1;
a third relaxed measurement parameter indicating a number of reference signals RS; where the number of reference signals is less than a reference number threshold; and
a fourth relaxed measurement parameter indicating a frequency domain range of BFD measurement; where the frequency domain range is smaller than a reference frequency domain range.

In one embodiment,
a relaxation degree for performing relaxed measurement using the first relaxed measurement parameter is greater than a relaxation degree threshold in response to the evaluation period indicated by the first relaxed measurement parameter being greater than an evaluation period threshold;
or,
the relaxation degree for performing relaxed measurement using the second relaxed measurement parameter is greater than the relaxation degree threshold in response to the indication interval indicated by the second relaxed measurement parameter being greater than an indication interval threshold;
or,
the relaxation degree for performing relaxed measurement using the third relaxed measurement parameter is greater than the relaxation degree threshold in response to the number of reference signals indicated by the third relaxed measurement parameter being greater than a reference number threshold;
or,
the relaxation degree for performing relaxed measurement using the fourth relaxed measurement parameter is greater than the relaxation degree threshold in response to the frequency domain range of the BFD measurement indicated by the fourth relaxed measurement parameter being greater than a reference frequency domain range. In one embodiment, the method further includes:

stopping the relaxed measurement of BFD in response to the BLER being greater than or equal to the BLER threshold;

and/or,
stopping the relaxed measurement of BFD in response to the terminal reporting a beam failure instance indication BFI;

and/or,
stopping the relaxed measurement of BFD in response to the BFD timer running. In one embodiment, the method further includes:

switching from a normal mode to a relaxation mode after waiting for a predetermined time in response to a need to switch from the normal mode to the relaxation mode;
or,
switching from the relaxation mode to the normal mode in response to a need to switch from the relaxation mode to the normal mode,

where the normal mode is a mode that does not use the relaxed measurement method to perform BFD measurement; and the relaxation mode is a mode that uses the relaxed measurement method to perform BFD measurement.

According to a second aspect of the embodiment of the present disclosure, a terminal, and includes a processor, where:
determine to trigger relaxed measurement of beam failure detection BFD according to a determination result of whether a predetermined condition is satisfied;
where the predetermined condition at least indicates: transmission quality of a wireless link that triggers relaxed measurement.

In one embodiment, the processor is further configured to:
determine to trigger the relaxed measurement of BFD in response to the determination result indicating that the predetermined condition is satisfied;
or,
determine not to trigger the relaxed measurement of BFD in response to the determination result indicating that the predetermined condition is not satisfied.

In one embodiment, the processor is further configured to:
determine to trigger the relaxed measurement of BFD in response to a block bit error rate BLER being less than or equal to a BLER threshold and a BFD timer not being started;
or,
determine to trigger the relaxed measurement of BFD in response to a count value of a counter of a media access control MAC layer of the terminal being equal to a counting threshold, where the counter counts in response to the MAC layer receiving a power saving indication reported by a physical layer of the terminal upon detection of the BLER being less than or equal to the BLER threshold, and the counter is reset to an initial value in response to triggering the relaxed measurement of BFD;
or,
determine to trigger the relaxed measurement of BFD in response to the BLER within a running duration of a preset timer of the physical layer of the terminal being less than or equal to the BLER threshold.

In one embodiment, the processor is further configured to:
determine to trigger the relaxed measurement of BFD in response to the MAC

layer of the terminal receiving the power saving indication of the physical layer, the BLER indicated by the power saving indication being than or equal to the BLER threshold and the BFD timer not being started;
or,
determine to trigger the relaxed measurement of BFD in response to the physical layer of the terminal receiving BFD timer information of the MAC layer, the BFD timer information indicating that the BFD timer is not started and the BLER being smaller than the BLER threshold.

According to a third aspect of the embodiment of the present disclosure, a terminal is provided, where the terminal includes:
a processor; and
a memory for storing instructions executable by the processor;
where the processor is configured to: execute the executable instructions, to implement the method of any embodiment of the present disclosure.

According to a fourth aspect, a computer storage medium is provided, which stores computer-executable instructions, which when being executed by a processor, implement the method of any embodiment of the present disclosure.

In the embodiment of the present disclosure, it is determined to trigger relaxed measurement of beam failure detection BFD according to a determination result of whether a predetermined condition is satisfied; where the predetermined condition at least indicates: transmission quality of a wireless link that triggers relaxed measurement. Here, the terminal can determine whether to trigger relaxed measurement of BFD or not to trigger relaxed measurement of BFD based on the determination result of whether the predetermined condition is satisfied. Compared with the mode in which relaxed measurement of BFD is always not used, it can adapt to the wireless link transmission quality, and trigger the relaxed measurement of BFD, thereby adjusting the power consumption of BFD, saving power, and improving the battery life of the terminal.

Other embodiments of the disclosure will be readily apparent to those skilled in the art from consideration of the specification and practice of the disclosure disclosed herein. This disclosure is intended to cover any modification, use or adaptation of the present disclosure, these modifications, uses or adaptations follow the general principles of the present disclosure and include common knowledge or conventional technical means in the technical field not disclosed in this disclosure. The specification and examples are to be considered exemplary only, with a true scope and spirit of the disclosure being indicated by the following claims.

It should be understood that the present disclosure is not limited to the precise constructions which have been described above and shown in the accompanying drawings, and various modifications and changes may be made without departing from the scope thereof. The scope of the disclosure is limited only by the appended claims.

1. A method for relaxed measurement, executed by a terminal, comprising:
determining to trigger relaxed measurement of beam failure detection (BFD) according to a determination result of whether a predetermined condition is satisfied;
wherein, the predetermined condition at least indicates: transmission quality of a wireless link that triggers relaxed measurement.

2. The method according to claim 1, wherein determining to trigger the relaxed measurement of BFD according to the determination result of whether the predetermined condition is satisfied comprises:
determining to trigger the relaxed measurement of BFD in response to the determination result indicating that the predetermined condition is satisfied;
or,
determining not to trigger the relaxed measurement of BFD in response to the determination result indicating that the predetermined condition is not satisfied.

3. The method according to claim 2, wherein determining to trigger the relaxed measurement of BFD in response to the determination result indicating that the predetermined condition is satisfied comprises:
determining to trigger the relaxed measurement of BFD in response to a block bit error rate (BLER) being less than or equal to a BLER threshold and a BFD timer not being started;
or,
determining to trigger the relaxed measurement of BFD in response to a count value of a counter of a media access control (MAC) layer of the terminal being equal to a counting threshold, wherein the counter counts in response to the MAC layer receiving a power saving indication reported by a physical layer of the terminal upon detection of the BLER being less than or equal to the BLER threshold, and the counter is reset to an initial value in response to triggering the relaxed measurement of BFD;
or,
determining to trigger the relaxed measurement of BFD in response to the BLER within a running duration of a preset timer of the physical layer of the terminal being less than or equal to the BLER threshold.

4. The method according to claim 3, wherein determining to trigger the relaxed measurement of BFD in response to the BLER being less than or equal to the BLER threshold and the BFD timer not being started, comprises:
determining to trigger the relaxed measurement of BFD in response to the MAC layer of the terminal receiving the power saving indication of the physical layer, the BLER indicated by the power saving indication being less than or equal to the BLER threshold and the BFD timer not being started;
or,
determining to trigger the relaxed measurement of BFD in response to the physical layer of the terminal receiving a BFD timer information of the MAC layer, the BFD timer information indicating that the BFD timer is not started and the BLER being less than or equal to the BLER threshold.

5. The method according to claim 4, further comprising:
obtaining, by the physical layer, the BLER threshold from the MAC layer through an inter-layer interface.

6. The method according to claim 1, wherein a relaxed measurement parameter of the relaxed measurement comprises one or more of:
a first relaxed measurement parameter indicating an evaluation period; wherein the evaluation period is N1 times of a reference evaluation period, wherein N1 is a positive number greater than 1;
a second relaxed measurement parameter indicating an indication interval; wherein the indication interval is N2 times of a reference indication interval, wherein N2 is a positive number greater than 1;
a third relaxed measurement parameter indicating a number of reference signals RS; wherein the number of reference signals is less than a reference number threshold; and
a fourth relaxed measurement parameter indicating a frequency domain range of BFD measurement; wherein the frequency domain range is smaller than a reference frequency domain range.

7. The method according to claim 6, wherein,
a relaxation degree for performing relaxed measurement using the first relaxed measurement parameter is greater than a relaxation degree threshold in response to the evaluation period indicated by the first relaxed measurement parameter being greater than an evaluation period threshold;
or,
the relaxation degree for performing relaxed measurement using the second relaxed measurement parameter is greater than the relaxation degree threshold in response to the indication interval indicated by the second relaxed measurement parameter being greater than an indication interval threshold;
or,
the relaxation degree for performing relaxed measurement using the third relaxed measurement parameter is greater than the relaxation degree threshold in response to the number of reference signals indicated by the third relaxed measurement parameter being greater than a reference number threshold;
or,
the relaxation degree for performing relaxed measurement using the fourth relaxed measurement parameter is greater than the relaxation degree threshold in response to the frequency domain range of the BFD measurement indicated by the fourth relaxed measurement parameter being larger than a reference frequency domain range.

8. The method according to claim 2, further comprising at least one of following acts:
stopping the relaxed measurement of BFD in response to the BLER being greater than or equal to the BLER threshold;
stopping the relaxed measurement of BFD in response to the terminal reporting a beam failure instance indication (BFI);
or,
stopping the relaxed measurement of BFD in response to the BFD timer running.

9. The method according to claim 1, further comprising:
switching from a normal mode to a relaxation mode after waiting for a predetermined time in response to a need to switch from the normal mode to the relaxation mode;
or,
switching from the relaxation mode to the normal mode in response to a need to switch from the relaxation mode to the normal mode,
wherein, the normal mode is a mode that does not use the relaxed measurement method to perform BFD measurement; and the relaxation mode is a mode that uses the relaxed measurement method to perform BFD measurement.

10. A terminal comprising a processor, wherein:
the processor is configured to:
determine to trigger relaxed measurement of beam failure detection (BFD) according to a determination result of whether a predetermined condition is satisfied;
wherein, the predetermined condition at least indicates: transmission quality of a wireless link that triggers relaxed measurement.

11. The terminal according to claim 10, wherein the processor is further configured to:
determine to trigger the relaxed measurement of BFD in response to the determination result indicating that the predetermined condition is satisfied;
or,
determine not to trigger the relaxed measurement of BFD in response to the determination result indicating that the predetermined condition is not satisfied.

12. The terminal according to claim 11, wherein the processor is further configured to:
determine to trigger the relaxed measurement of BFD in response to a block bit error rate (BLER) being less than or equal to a BLER threshold and a BFD timer not being started;
or,
determine to trigger the relaxed measurement of BFD in response to a count value of a counter of a media access control (MAC) layer of the terminal being equal to a counting threshold, wherein the counter counts in response to the MAC layer receiving a power saving indication reported by a physical layer of the terminal upon detection of the BLER being less than or equal to the BLER threshold, and the counter is reset to an initial value in response to triggering the relaxed measurement of BFD;
or,
determine to trigger the relaxed measurement of BFD in response to a running duration of a preset timer of the physical layer of the terminal being shorter than a timing period and the BLER being less than or equal to the BLER threshold.

13. The terminal according to claim 12, wherein the processor is further configured to:
Determine to trigger the relaxed measurement of BFD in response to the MAC layer of the terminal receiving the power saving indication of the physical layer, the BLER indicated by the power saving indication being less than or equal to the BLER threshold and the BFD timer not being started;
or,
determine to trigger the relaxed measurement of BFD in response to the physical layer of the terminal receiving BFD timer information of the MAC layer, the BFD timer information indicating that the BFD timer is not started and the BLER being less than or equal to the BLER threshold.

14. A terminal, comprising:
an antenna;
a memory; and
a processor, respectively connected to the antenna and the memory, and configured to control transmission and reception of the antenna by executing computer-executable instructions stored on the memory, and to implement acts comprising:
determining to trigger relaxed measurement of beam failure detection (BFD) according to a determination result of whether a predetermined condition is satisfied;
wherein, the predetermined condition at least indicates: transmission quality of a wireless link that triggers relaxed measurement.

15. A non-transitory computer storage medium having stored thereon computer-executable instructions, the computer-executable instructions, when executed by a processor, causing the processor to implement acts according to claim 1.

16. The terminal according to claim 13, wherein the processor is further configured to:
obtain, by the physical layer, the BLER threshold from the MAC layer through an inter-layer interface.

17. The terminal according to claim 10, wherein a relaxed measurement parameter of the relaxed measurement comprises one or more of:
a first relaxed measurement parameter indicating an evaluation period; wherein the evaluation period is N1 times of a reference evaluation period, wherein N1 is a positive number greater than 1;
a second relaxed measurement parameter indicating an indication interval; wherein the indication interval is N2 times of a reference indication interval, wherein N2 is a positive number greater than 1;
a third relaxed measurement parameter indicating a number of reference signals RS; wherein the number of reference signals is less than a reference number threshold; and
a fourth relaxed measurement parameter indicating a frequency domain range of BFD measurement; wherein the frequency domain range is smaller than a reference frequency domain range.

18. The terminal according to claim 17, wherein,
a relaxation degree for performing relaxed measurement using the first relaxed measurement parameter is greater than a relaxation degree threshold in response to the evaluation period indicated by the first relaxed measurement parameter being greater than an evaluation period threshold;
or,
the relaxation degree for performing relaxed measurement using the second relaxed measurement parameter is greater than the relaxation degree threshold in response to the indication interval indicated by the second relaxed measurement parameter being greater than an indication interval threshold;
or,
the relaxation degree for performing relaxed measurement using the third relaxed measurement parameter is greater than the relaxation degree threshold in response to the number of reference signals indicated by the third relaxed measurement parameter being greater than a reference number threshold;
or,
the relaxation degree for performing relaxed measurement using the fourth relaxed measurement parameter is greater than the relaxation degree threshold in response to the frequency domain range of the BFD measurement indicated by the fourth relaxed measurement parameter being larger than a reference frequency domain range.

19. The terminal according to claim 11, wherein the processor is further configured to:
stop the relaxed measurement of BFD in response to the BLER being greater than or equal to the BLER threshold;
stop the relaxed measurement of BFD in response to the terminal reporting a beam failure instance indication (BFI);
or,
stop the relaxed measurement of BFD in response to the BFD timer running.

20. The terminal according to claim 10, wherein the processor is further configured to:
switch from a normal mode to a relaxation mode after waiting for a predetermined time in response to a need to switch from the normal mode to the relaxation mode;
or,
switch from the relaxation mode to the normal mode in response to a need to switch from the relaxation mode to the normal mode,
wherein, the normal mode is a mode that does not use the relaxed measurement method to perform BFD measurement; and the relaxation mode is a mode that uses the relaxed measurement method to perform BFD measurement.
